(19) United States
(12) Patent Application Publication
(10) Pub. No.: US 2018/0091356 A1
(43) Pub. Date: Mar. 29, 2018

(54) COMBINATORIAL INTERNET BANDWIDTH

(71) Applicant: GOOGLE INC., Mountain View, CA (US)

(72) Inventor: Ryan Tabone, San Francisco, CA (US)

(73) Assignee: GOOGLE INC., Mountain View, CA (US)

(21) Appl. No.: 13/754,423

(22) Filed: Jan. 30, 2013

Related U.S. Application Data
(60) Provisional application No. 61/601,309, filed on Feb. 21, 2012.

(51) Int. Cl. G06F 17/30

(52) U.S. Cl. CPC H04L 41/00

(57) ABSTRACT

According to one general aspect, a method may include aggregating a plurality of network interfaces into a combinatorial network interface group, wherein each network interface provides a respective amount of bandwidth to at least one communications network. The method may also include receiving a request, from an application, to access at least one network resource via a communications network. The method may also include selecting at least one network interface included by the combinatorial network interface group to fulfill the network request based, at least in part, upon the bandwidth provided by the combination of bandwidths provided by the selected network interfaces. The method may further include accessing the network resource via the selected network interface.

### CROSS REFERENCE TO RELATED APPLICATION

This application claims the benefit of U.S. Provisional Application No. 61/601,309, filed on Feb. 21, 2012, which is incorporated by reference in its entirety herein.

### TECHNICAL FIELD

This description relates to the communication of information via a network, and more specifically to the communication of information using a plurality of network interfaces.

### BACKGROUND

Traditionally, a computing device (e.g., desktop computer, laptop, smartphone, tablet, etc.) makes use of a single network interface at a time. Traditionally, the computing device's network interface connects to a given communications network (e.g., the Internet, a cellular data network, etc.). If the computing device wishes to communicate with another device on the communications network or access a network resource (e.g., a file, a service, etc.), the computing device routes all such network traffic through the network interface connected to the network.

Often, all network traffic for a computing device is routed through a given network interface. Generally, if a computing device includes multiple network interfaces (a wired interface, a Wi-Fi interface, a cellular data interface, etc.), a primary network interface is selected and all network traffic is routed through that primary interface.

Generally, when a computing device connects to a given network, the device identifies the network interface used to connect to the network, what resources are available on a network, what protocols are needed to talk to different parts of the network (e.g., a short message service (SMS) server, a file server, etc.) or perform different actions via the network (e.g., sending an text message, transferring a file, etc.) and/or what programmatic interfaces to use.

In addition, often communication networks (e.g., a cellular data network, an Internet service provider network, etc.) may connect with other communication networks (e.g., an Internet Protocol (IP) backbone, a Tier 2 network, etc.). The Internet is generally regarded as a system of interconnected communications networks.

### SUMMARY

According to one general aspect, a method may include aggregating a plurality of network interfaces into a combinatorial network interface group, wherein the plurality of network interfaces may include network interfaces of diverse types, and wherein each network interface provides a respective amount of bandwidth to at least one communications network. The method may also include receiving a request, from an application, to access at least one network resource via a communications network. The method may also include selecting at least one network interface included by the combinatorial network interface group to fulfill the network access request. The selection may be based, at least in part, upon the bandwidth provided by the combination of the selected network interfaces.

According to another general aspect, an apparatus may include a processor and a plurality of network interfaces. The plurality of network interfaces may include network interfaces of diverse types. Each network interface may facilitate the communication of the apparatus with at least one communications network. The processor may be configured to cause the apparatus to aggregate at least a portion of the plurality of network interfaces into a combinatorial network interface group, receive a request to access at least one network resource via a communications network, select at least one network interface included by the combinatorial network interface group to fulfill the network request, and access the network resource via the selected network interface.

According to another general aspect, computer program products for accessing information may be tangibly embodied on a computer-readable medium and include executable code. The executable code may, when executed, cause an apparatus to aggregate a plurality of network interfaces into a combinatorial network interface group, wherein the plurality of network interfaces may include network interfaces of diverse types. Each network interface provides a respective amount of bandwidth to at least one communications network. The executable code may, when executed, further cause the apparatus upon receiving a request, from an application, to access at least one network resource via a communications network, select at least one network interface included in the combinatorial network interface group to fulfill the network access request based, at least in part, upon the bandwidth provided by the combination of the selected network interfaces, and access the network resources via the selected network interfaces.

The details of one or more implementations are set forth in the accompanying drawings and the description below. Other features will be apparent from the description and drawings, and from the claims.

A system and/or method for communicating information, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a block diagram of an example embodiment of a system in accordance with the disclosed subject matter.

FIG. 3 is a block diagram of an example embodiment of a system in accordance with the disclosed subject matter.

FIG. 4 is a block diagram of an example embodiment of a system in accordance with the disclosed subject matter.

FIG. 5 is a flowchart of an example embodiment of a technique in accordance with the disclosed subject matter.

FIG. 6 shows an example of a generic computer device and a generic mobile computer device, which may be used with the techniques described here.

Like reference symbols in the various drawings indicate like elements.

### DETAILED DESCRIPTION

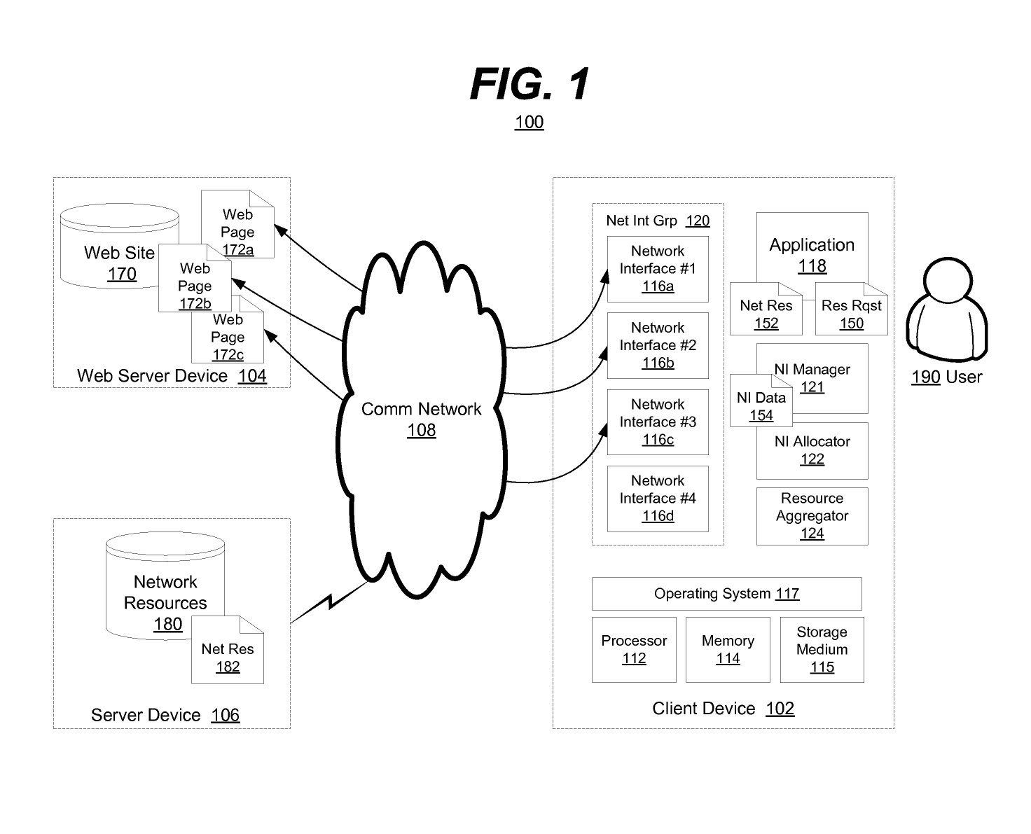

FIG. 1 is a block diagram of an example embodiment of a system 100 in accordance with the disclosed subject matter. In one embodiment, the system 100 may include a client computing device 102, with a plurality of network interfaces 116, that is connected with or part of a communications network 108 and in communication with at least one server device 104 and/or 106.

In various embodiments, the client device 102 may include a computing device, such as, for example, a shared computing terminal, a thin client, a desktop personal computer, a laptop, a netbook, a tablet, a smartphone, etc. or a virtual machine thereof. In various embodiments, the client device 102 may be used by a user 190. In various embodiments, the computing device 102 may include a processor 112 configured to execute one or more machine executable instructions or pieces of software, firmware, or a combination thereof. The computing device 102 may include, in some embodiments, a memory 114 configured to store on or more pieces of data, either temporarily, permanently, semi-permanently, or a combination thereof. Further, the memory 114 may include volatile memory, non-volatile memory or a combination thereof. In various embodiments, the computing device 102 may include a storage medium 115 configured to store data in a semi-permanent or substantially permanent form. In various embodiments, the storage medium 115 may be included by the memory 114.

In some embodiments, the computing device 102 may include one or more network interfaces (NIs) 116 (e.g., network interfaces 116a, 116b, 116c, and 116d, etc.) each configured to associate with and communicate via one or more communication networks (e.g., a wired network, a wireless network, a cellular network, etc.). In various embodiments, one or more of the network interfaces 116 may be virtual or logical as opposed to physical. However, in a preferred embodiment, the majority of network interfaces 116 may include distinct hardware relative to the type, kind, or protocol of a communications network 108 that NI 116 is intended to access (e.g., an antenna tuned to ˜2.4 GHz, an antenna tuned to 2-8 GHz, an RJ45 physical port for accepting a wire/cable with a 8P8C modular plug, etc.).

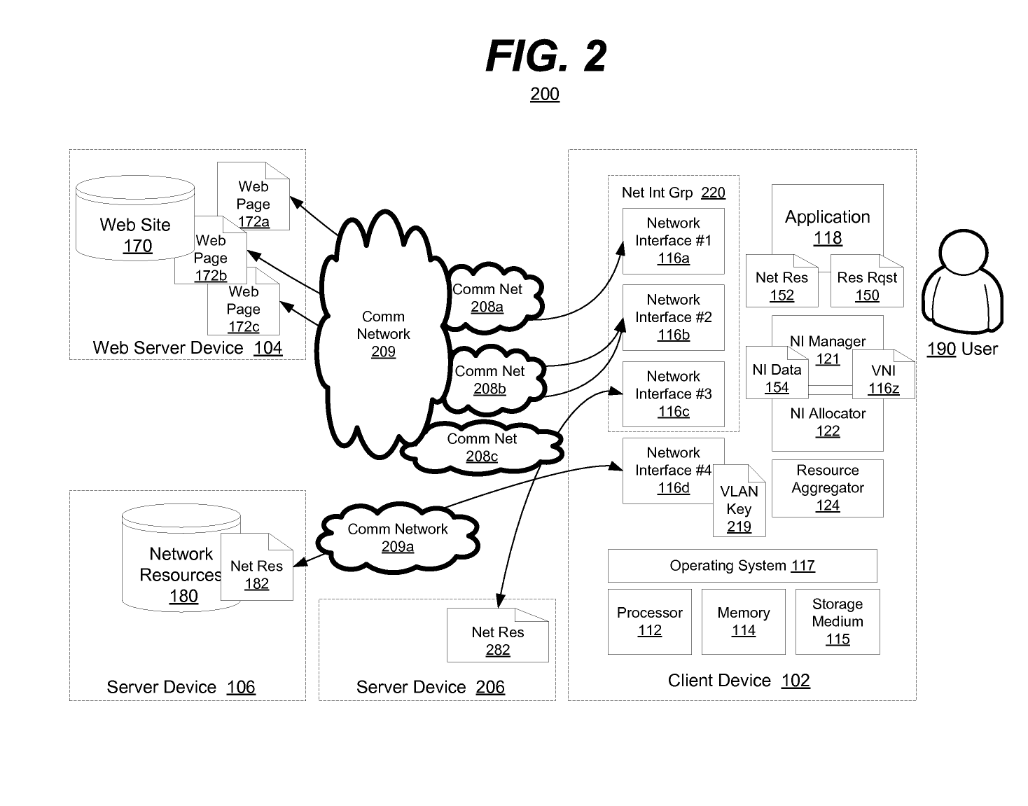

In the illustrated embodiment, the various Nis 116a, 116b, 116c, and 116d may all access or ultimately be part of a common communications network 108 (e.g., the Internet, etc.). Each of these Nis 116 may access the communications network 108 communications network 108 via a different communications protocol (e.g., a Wi-Fi or Wireless Local Area Network (LAN) protocol, a cellular data protocol, a wired protocol, etc.) or communication network (e.g., a home LAN, a cellular company's communications network, a business intranet, etc.). For the sake of simplifying the illustration, these individual communications networks are not shown in FIG. 1; however, such networks are illustrated in FIG. 2. It is understood that the above are merely a few illustrative examples to which the disclosed subject matter is not limited.

Examples of a Wi-Fi protocol may include, but are not limited to: Institute of Electrical and Electronics Engineers (IEEE) 802.11g, IEEE 802.11n, etc. Examples of a cellular protocol may include, but are not limited to: IEEE 802.16m (a.k.a Wireless-MAN (Metropolitan Area Network) Advanced), Long Term Evolution (LTE) Advanced), Enhanced Data rates for GSM (Global System for Mobile Communications) Evolution (EDGE), Evolved High-Speed Packet Access (HSPA+), etc. Examples of a wired protocol may include, but are not limited to: IEEE 802.3 (a.k.a. Ethernet), Fibre Channel, Power Line communication (e.g., HomePlug, IEEE 1901, etc.), etc. It is understood that the above are merely a few illustrative examples to which the disclosed subject matter is not limited.

In various embodiments, the computing device 102 may include one or more other hardware components (not shown) (e.g., a display or monitor, a keyboard, a touchscreen, a camera, a fingerprint reader, a video processor, etc.).

In various embodiments, the computing device 102 may include an operating system (OS) 117 configured to provide one or more services to an application 118 and manage or act as an intermediary between the applications 118 and the various hardware components (e.g., the processor 112, a network interface 116, etc.) of the computing device 102. In such an embodiment, the computing device 102 may include one or more native applications 118, which may be installed locally (e.g., within the storage medium 115, etc.) and configured to be executed directly by the processor 112 and directly interact with the OS 117. In such an embodiment, the native applications 118 may include pre-compiled machine executable code. In some embodiments, the native applications 118 may include a script interpreter (e.g., C shell (csh), AppleScript, AutoHotkey, etc.) or a virtual machine (e.g., the Java Virtual Machine, the Microsoft Common Language Runtime, etc.) that are configured to translate source or object code into executable code which is then executed by the processor 112.

In some embodiments, the application 118 may include a web browser configured to access a server device 106 or a network resource 182. In various embodiments, a network resource 182 may include one or more pieces of data (e.g., web page, media file, document, video, image, data object, etc.) or devices (e.g., a printer, a web camera, a sensor, etc.) that may be accessed via the communications network 108. In various embodiments, the client device 102 may request the network resource 182 (e.g., download a web application, etc.) or transmit data to a network resource (e.g., upload images to a social media site, etc.). In a specific version of the illustrated embodiment, a network resource may include a web site or a collection of web pages, scripts, etc. from a physically remote server or web server (e.g., web server device 104, etc.). It is understood that the above is merely one illustrative example to which the disclosed subject matter is not limited.

In this context, a “web page” includes a file or document which is a portion of a web site. In various embodiments, such web pages may include a file formatted as Hypertext Markup Language (HTML), Cascading Style Sheets (CSS), JavaScript, Extensible Markup Language (XML) such as a XHTML (Extensible HyperText Markup Language) file, an Adobe Flash file, images, videos, etc. In various embodiments, the web browser 118 may process one or more web pages in order to render one web page. For example, an HTML web page may be modified or include other web pages, such as, JavaScripts, a CSS file, various images, etc. In this context, a web page that includes, often by reference, other web pages is referred to as a “base web page”. For example, when a user 190 views a “web page” from a web site that web page is often a “base web page” that includes graphics, and CSS styles, etc. Generally, the location or address bar of the web browser 118 merely displays the URL of the base web page (e.g., http://www.google.com/index.html, etc.), and not each incorporated or subordinate web page (e.g., a logo graphic, such as, http://www.google.com/intl/en_com/images/srpr/logo2w.png, etc.). It is understood that the above is merely one illustrative example to which the disclosed subject matter is not limited.

In this context, a “web site” may include a collection or grouping of related web pages that are generally viewable or understandable (once rendered by the web browser 118) to the user 190. In various embodiments, when a web site (e.g., web site 170, etc.) is accessed via a communications network, the web site may be accessed via the Hypertext Transfer Protocol (HTTP) or Hypertext Transfer Protocol Secure (HTTPS). It is understood that the above is merely one illustrative example to which the disclosed subject matter is not limited.

In various embodiments, the client device 102 may group or aggregate one or more NIs 116 into a combinatorial network interface group 120. In such an embodiment, the client device 102 may be configured to allocate network communications requests or tasks (e.g., uploads, downloads, etc.) not to a preferred or active network interface 116, as is traditional done, but to the network interface group 120 as a whole. The network communications requests or tasks may then be assigned to one or more NIs 116 for actual fulfillment (e.g., downloading a requested network resource 182, etc.) based on one or more predefined criteria, as described below.

In various embodiments, the network interface group 120 may be configured to allow the client device 102 to take advantage of the sum or a combination of the respective bandwidth capabilities provided by each NI 116 in the network interface group 120. In such an embodiment, the network interface group 120 may be configured to allow a network resource 182 to be accessed more quickly or more efficiently than it would be if a single or preferred NI 116 was employed.

For example, in one specific embodiment, NI 116a may include a NI configured to access the communications network 108 via a wired protocol (e.g., Ethernet, etc.) with a symmetrical bandwidth or data rate of approximately 100 Gigabits per second (Gbps). NI 116b may include a NI configured to access communications network 108 via a cellular data protocol (e.g., a 4G protocol, etc.) with an asymmetrical bandwidth or data rate of approximately 128 Megabits per second (Mbps) for a download and 56 Mbps for an upload. NI 116c may include a NI configured to access communications network 108 via a first WLAN or Wi-Fi protocol (e.g., an IEEE 802.11g protocol, etc.) with a theoretical maximum bandwidth or data rate of approximately 54 Megabits per second (Mbps). NI 116d may include a NI configured to access communications network 108 via a first WLAN or Wi-Fi protocol (e.g., an IEEE 802.11n protocol, etc.) with a theoretical maximum bandwidth or data rate of approximately 150 Megabits per second (Mbps).

Also, NI 116b may be associated with or limited to a total bandwidth cap of 5 Gigabytes (Gb) per month. In some embodiments, the monthly bandwidth cap may be raised by set amounts (e.g., 1 Gb) for a predefined price or cost amount (e.g., $25). In contrast NIs 116a, 116c, and 116d may not be subject to any cap or aggregate bandwidth limit. It is understood that the above are merely a few illustrative examples to which the disclosed subject matter is not limited.

In one embodiment, these NIs 116 may be grouped or aggregated together into a combinatorial network interface group 120 by an NI manager 121. In various embodiments, NI Manager 121 may maintain or store (e.g., via memory 114) a set of NI data 154. In such an embodiment, NI data 154 may include, for example, one or more of the following: the protocol of each NI 116, the status (e.g., connected, turned off, in a low-power mode, receiving, sending, etc.) of each NI, which network a NI is connected with, the network addresses (e.g., MAC, IP addresses, etc.), the bandwidth capabilities of each NI, and any bandwidth caps or pricing structures associated with a NI, etc. It is understood that the above are merely a few illustrative examples to which the disclosed subject matter is not limited.

In one embodiment, user 190, via application 188, may request one or more network resources 152 (illustrated as network request 152). Traditionally, network request 152 would be assigned to a primary or preferred NI 116 (e.g., NI 116a).

In a specific embodiment, the network resource 152 may include a portion of web site 170. In such an embodiment, web site 170 may include a plurality of web pages 172a, 172b, or 172c, etc. In various embodiments, application 118 or user 190 may request web page 172a from web site 170. In some embodiments, the application 118 may make a resource request 150 to NI manager 121. In such an embodiment, NI manager 121 may be configured to, for example, via NI Allocator 122, allocate or distribute the retrieval of the network resource 172a to a first NI (e.g., NI #1 116a).

In such an embodiment, the assigned NI #1 116a may retrieve network resource 172a. In various embodiments, this web page 172a may include a base web page, as described above, that calls or includes other web pages (e.g., web pages 172b and 172c, etc.). In such an embodiment, application 118 may subsequently request the additional or subordinate web pages 172b and 172c. In one such embodiment, NI Allocator 122 may select one NIs 116 from NI Group 120 to perform this network resource retrieval or access. In one illustrative embodiment, NI Allocator 122 may employ a round-robin-like scheme in which each NI 166 is selected in turn. In such an embodiment, NI #2 116b may be selected to fulfill the network request for web page 172b, and NI #3 116c may be selected to fulfill the network request for web page 172c. It is understood that the above is merely one illustrative example to which the disclosed subject matter is not limited.

In various embodiments, application 118 may make a single or combined request to access or retrieve one or more network resources (e.g., web pages 172a, 172b, and 172c, etc.). In such an embodiment, NI Allocator 122 may be configured to allocate the accessing or fulfillment of the respective network resources to one or more NIs. For example, the retrieval request 150 may have included a request to access the three web pages 172a, 172b, and 172c. NI Allocator 122 may then have divided the combined request into discrete portions or requests and allocated each request to be fulfilled by a selected NI 116. In the illustrated embodiment, the request for web page 172a may have been allocated to NI #1 116a, web page 172b to NI #2 116b, and likewise web page 172c to NI #3 116c.

In various embodiments, in which more network resources are requested than there are NIs 116 in NI Group 120 one or more various schemes may be employed to allocate access requests amongst NIs 116. For example, a round-robin system may be employed, a weighted allocation (e.g., based upon bandwidth, usage cost, etc.) may be employed, a token-bucket system in which NIs are associated with “tokens” or some other marker which indicates that a certain amount to bandwidth or usage has occurred and allocating access requests to preferred NIs unless NI's respective “tokens” are used or would be used by the current access, etc. It is understood that the above are merely a few illustrative examples to which the disclosed subject matter is not limited.

FIG. 2 is a block diagram of an example embodiment of a system 200 in accordance with the disclosed subject matter. In one embodiment, system 200 may include a client computing device 102, with a plurality of network interfaces (NIs) 116, that is connected with or part of a communications network 209 and in communication with at least one server device 104, 106, and/or 206.

Similarly to that shown in FIG. 1, system 200 of FIG. 2 may include a plurality of network interfaces (NIs) 116, some of which are aggregated into a combinatorial NI Group 220. In the illustrated embodiment, NIs 116a, 116b, and 116c may, for example, be aggregated into NI Group 220. In various embodiments, NI 116d may exist separately outside of NI Group 220. In such an embodiment, NI 116d may be managed by NI Manager 121 or managed separately by device 102 (e.g., via the processor 112 or OS 117, etc.).

In a less preferred embodiment, NI 116d may be considered to be a second NI Group similar to NI Group 220, but including only a single member. In another embodiment, the second NI Group may include multiple NIs 116. In some embodiments, a NI 116 may belong or be included by multiple NI Groups. Generally, this illustrates that in various embodiments, multiple NI Groups may be employed.

As described above, in various embodiments, application 118 may make various requests 150 to access one or more network resources (e.g., network resources 182, 282, web pages 172, etc.). In such an embodiment, NI Allocator 122 may select one or more NIs 116 to fulfill these various network resource access requests. In various embodiments, these allocations may be dynamic or vary over time as network conditions (e.g., routes, connections, latency, bandwidth caps, etc.) change.

For example, as described above, NI 116a may be connected with a wired communications network 208a (which is then in turn connected with the communications network 209, for example the Internet). As such, NI 116a may be the preferred NI 116 and may be allocated as much resource accessing tasks as it can fulfill (e.g., web page 172a). However, in one embodiment, communications network 208a may experience a degradation in performance (e.g., high latency, another device may dominate the network, etc.). In such an embodiment, NI Allocator 122 may allocate other network resource access tasks (e.g., web pages 172b and 172c, etc.) to a less preferred NI (e.g., NI 116b). In various embodiments, other allocation schemes may be employed.

In one embodiment, NI Allocator 112 may be configured to select a NI 116 based upon the network topology. In various embodiments, a network address or portion thereof may be employed to determine or in place of information regarding the network topology. For example, a user 190 may wish to access network resource 282. In such an embodiment, NI Allocator 122 may be configured to generally allocate the access to NI 116b. However, the network resource 282 may be on the same communications network 208c as NI 116c (whereas NI 116b may be directly coupled with communications network 208b). As such, by accessing the resource 282 via NI 116c may be “better than” if the resource 282 was accessed via NI 116b.

In various embodiments, “better than” or a relative determination may be based upon one or more factors, for example, it may be assumed the intra-network accesses may be faster or cheaper than inter-network accesses, accesses via NI 116b may be faster but more expensive than accesses via NI 116c, etc. For example, accesses via NI 116b may be associated with a cost (e.g., aggregate bandwidth cap, per access monetary fee, per day monetary fee, etc.) and NI 116c may not be. In one embodiment, NI Allocator 122 may be aware of a cost (e.g., monetary, speed, etc.) incurred by accessing a certain portion of a network (e.g., network 209) that may be avoided (e.g., by avoiding that network portion) if a certain NI 116 is selected.

In another embodiment, selecting a various network resources may be based upon a resource category or quality of service category. For example, a user 190 or device 102 may be configured to indicate that for various categories of data or resources speed or reliability may be more important than monetary cost, whereas for others monetary cost may be more important than speed. For example, for real-time data (e.g., voice-over-Internet-Protocol (VoIP), etc.) the user 190 may instruct or indicate via a settings file that speed is more important than monetary cost. In such an embodiment, NI Allocator 122 may allocate that category of data or resource access to the faster NI 116b even though NI 116b may be associated with a monetary cost (e.g., as recorded in NI Data 154, etc.). Conversely, non-real-time data may be allocated to NI 116c. It is understood that the above is merely one illustrative example to which the disclosed subject matter is not limited. In various embodiments, the categories may be based upon, for example, file type (e.g., HTML, MPEG, etc.), network address or location, resource size (e.g., physical file byte size, encoding bit size, etc.), etc. It is understood that the above are merely a few illustrative examples to which the disclosed subject matter is not limited.

In one embodiment, NI Allocator 122 may select a NI 116 outside of NI Group 220 to access the network resource (e.g., resource 182). For example, in one embodiment, NI 116d may be outside NI Group 220 and may also be included within or as part of a Virtual Local Area Network (VLAN) 209a or other encryption or private tunneling scheme. In such an embodiment, NI Manager 121 may have removed NI 116d from or not included NI 116d within NI Group 220 in order to maintain a separation of network access requests. In the illustrated embodiment, NI 116d may include, maintain, or be associated with a VLAN certificate or encryption key 219.

For example, a user 190 may use VLAN 209a to access work-based network resources (e.g., resource 182). The user 190 may wish to keep their personal network accesses (e.g., illustrated as using network 209) isolated from their work-based network accesses. In such an embodiment, NI Manger 121 or OS 117 may be configured to select NI 116d for any network resource accesses (e.g., resource 182) that are accessible via the VLAN 209a and NI Group 220 for any network resource accesses (e.g., resources 172a, 282, etc.) that are accessible without using the VLAN 209a. In some embodiments in which NI 116d is treated by device 102 as a second NI Group, NI Allocator 122 may be configured to maintain the distinction between the VLAN 209 NI 116d and non-VLAN NIs 116. In another embodiment (not explicitly illustrated), separate NIs within NI Group 220 (e.g., NI 116a, etc.) may make use of a VLAN, tunneling scheme, or encryption scheme and NI Allocator 122 may select NIs based upon a NI's association with or lack thereof such a scheme. It is understood that the above is merely one illustrative example to which the disclosed subject matter is not limited.

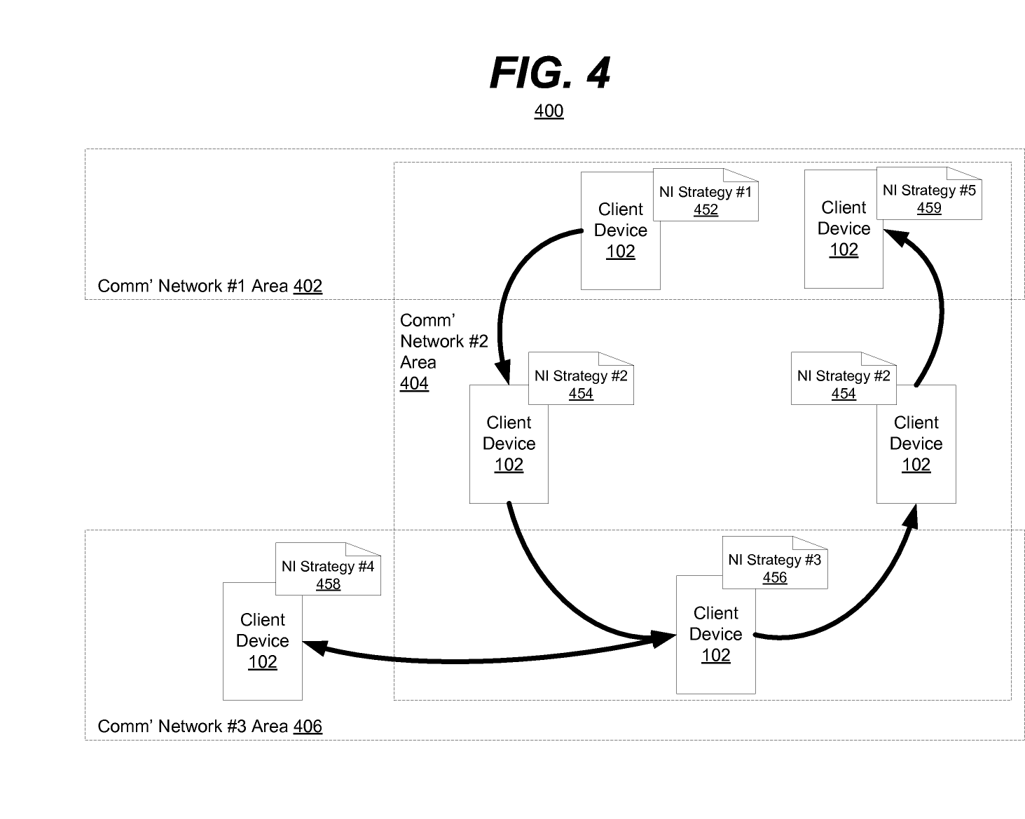

In some embodiments, NI Manager 121 may be configured to divide or select NIs 116 for aggregation into NI Group 220 based upon the communications networks associated with the respective NIs 116. In such an embodiment, NI 116d, as part of VLAN 209a, may have been excluded from NI Group 220 due to its association with the VLAN 209a. In another embodiment, illustrated more in FIG. 4, NI Manager may alter or re-aggregate NIs 116 into various forms of NI Group 220 as network conditions change (e.g., a network is disconnected, an aggregate bandwidth cap is reached, a physical location of device 102 changes, etc.). It is understood that the above are merely a few illustrative examples to which the disclosed subject matter is not limited.

In yet another embodiment, NI Group 220 may be aggregated into or included by a virtual NI (VNI) 116z. In such an embodiment, the OS 117 may be configured to generally view the VNI 116z as another NI 116. In such an embodiment, NI Manager 121 may “hide” NIs 116a, 166b, and 116c of NI Group 220 behind the VNI 116z such that the OS 117 or application 118 sends/receives access requests/responses to the VNI 116z and NI Manager 121 allocates those resource accesses out to the various NIs 116 (e.g., NIs 116a, 116b, or 116c, etc.) of NI Group 220, as described above. In such an embodiment, the OS 117 may not be actively aware of NI Group 220 or the aggregation of a plurality of NIs 116 into a combinatorial grouping. In such an embodiment, NI Manager 121, NI Allocator 122, etc. may be handled or included by device 102 at the driver-level and not at an OS-level. In various embodiments, the handling of the grouping or aggregating of a plurality of NIs 116 into a combinatorial grouping and the allocating of network resource access requests amongst NI grouping may be handled or processed at various levels of the software architecture (e.g., driver, OS, application, etc.). It is understood that the above are merely a few illustrative examples to which the disclosed subject matter is not limited.

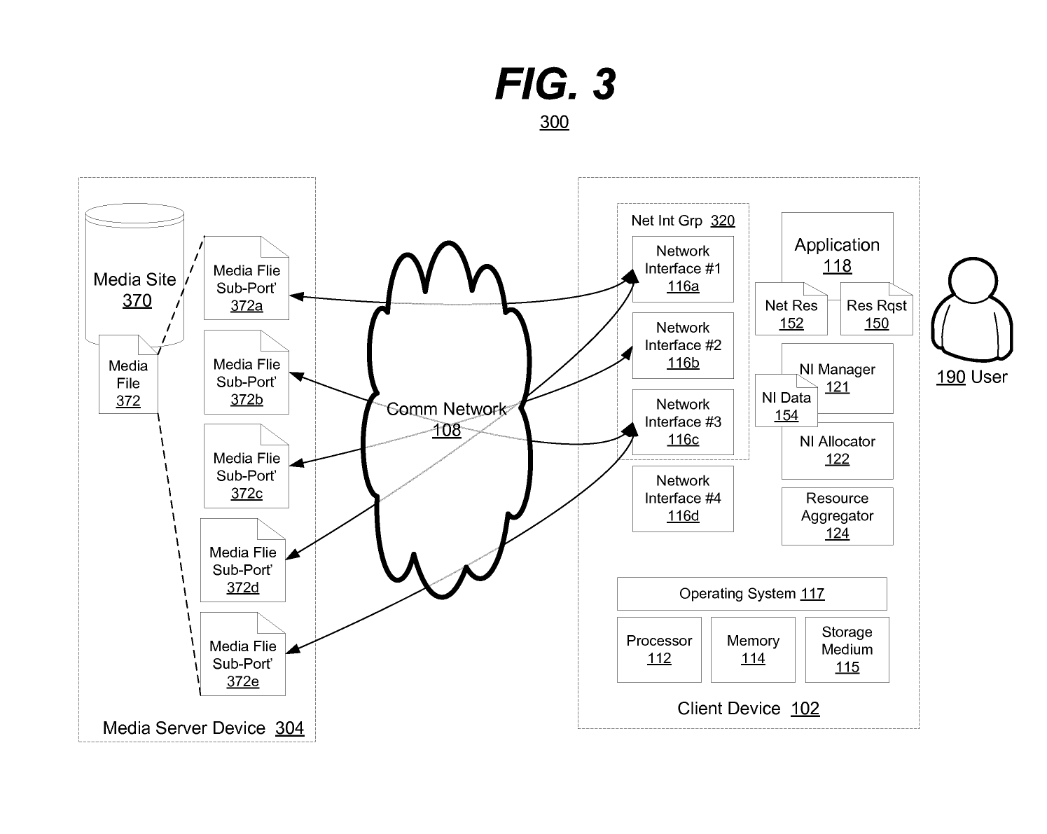

FIG. 3 is a block diagram of an example embodiment of a system 300 in accordance with the disclosed subject matter. In one embodiment, system 300 may include a client computing device 102, with a plurality of network interfaces (NIs) 116, that is connected with or part of a communications network 108 and in communication with at least one server device 304.

In the illustrated embodiment, server device 304 (e.g., a media server, etc.) may include a media site 370 that may, for example, host movies, music files, etc. over a web or Internet interface. In such an embodiment, media site 370 may include a media file 372 (e.g., a movie, etc.). In such an embodiment, user 190 may request the media file 372 from the media server 304.

In various embodiments, media file 372 may be subdivided into a plurality of smaller sub-portions (e.g., sub-portions 372a, 372b, 372c, 372d, 372e, etc.). In some embodiments, media file 372 may already be subdivided into portions by the media server 304. For example, a base web page may include multiple subordinate web pages, as described above, or a media file 372 may include a playlist of smaller media files, etc. In another embodiment, media file 372 may not include individual smaller files may be associated with a definition scheme that defines sub-portions. For example, when accessing a media file 372 that employs a peer-to-peer file sharing protocol (e.g., BitTorrent, etc.) or a distributed content delivery system, a variety of sub-portions of file 372 may already be defined. In a less preferred embodiment, the network protocol employed to access the media file 372 may allow for the dynamic definition by the client of sub-portions (e.g., by media file time, such as 0:00 minute mark to the 1:00 minute mark, 1:01 to 2:00 minute marks, etc.). It is understood that the above are merely a few illustrative examples to which the disclosed subject matter is not limited.

In various embodiments, requesting application 118 may be unaware of the sub-portion definition. In another embodiment, NI Manager 121 may be made aware of the sub-portion definition and may allowed to manage the accessing of the network resource (e.g., media file 372) instead of receiving a series of individual requests to access each sub-portion. It is understood that the above are merely a few illustrative examples to which the disclosed subject matter is not limited.

In such an embodiment, NI Manager 121 may cause each sub-portion (e.g., sub-portion 372a, etc.) to be accessed by various respective selected NIs 116 of NI Group 320. In the illustrated embodiment, NI 116a may be selected to access sub-portions 372a and 372d; NI 116b may be selected to access sub-portion 372c; and NI 116c may be selected to access sub-portions 372b and 372e.

In various embodiments, a number of these sub-portions may be accesses substantially simultaneously. For example, sub-portions 372a, 372b, and 372c are accessed by different NIs 116 and may be accessed in parallel versus in series or in a pipelined fashion.

In various embodiments, sub-portions 372a, etc. may be accessed out-of-order and may require being re-arranged from their received or accessed order. For example, sub-portion 372d may be received by device 102 after sub-portion 372a but before sub-portion 372c. In various embodiments, the accessing protocol (e.g., BitTorrent, etc.) may allow for this asynchronous resource access. In another embodiment, the sub-portions may be cached or stored temporarily (e.g., in memory 114 or storage medium 115, etc.) until the resource 372 sub-portions may be aggregated or rearranged into the proper resource 372. In such an embodiment, device 102 may include a resource aggregator 124 configured to aggregate or re-arrange any out-of-order sub-portions. In various embodiments, resource aggregator 124 may be a plug-in or add-in utilized based upon the underlying network access protocol. It is understood that the above is merely one illustrative example to which the disclosed subject matter is not limited.

FIG. 4 is a block diagram of an example embodiment of a system 400 in accordance with the disclosed subject matter. In one embodiment, the system 400 may include a mobile client computing device 102 that interacts with a plurality of communications network 402, 404 and 406 via a plurality of network interfaces and accesses various network resources (not shown). As described above, a portion or all of the network interfaces may be aggregated into a combinatorial network interface group.

In various embodiments, NI Allocator may dynamically reallocate the accessing of the network resources amongst the selected network interfaces based upon a change in the capabilities or status of the network interfaces. Additionally, in various embodiments, NI Manager may re-define or re-aggregate the plurality of network interfaces into a combinatorial network interface group based upon a change in the capabilities or status of the network interfaces.

In some embodiments, the change in the capabilities or status of the network interfaces may include, for example, NI becoming disconnected from a network, changes in bandwidth available to the network interface (e.g., the exceeding of a bandwidth cap, network congestion, etc.), the association of NI with an encryption scheme, a change in the power status of NI (e.g., hibernated, turned off, etc.), or other various changes in NIs. In various embodiments, the change may not be directly to NI or a network associated with NI, but to another sensor (e.g., near-field communication, short-range radio), global position system (GPS) sensor, etc. For example, NI Strategy may change based upon the location of device 102, or the presence of a user as detected by a Bluetooth radio transmitter. It is understood that the above are merely a few illustrative examples to which the disclosed subject matter is not limited.

In the illustrated embodiment, three networks are shown. Network #1 may include a work network with various firewall or other security structures and providing very generous network bandwidth and speed. Network #2 may include a cellular data network to which the user subscribes and may not include the type of security structures found within network #1 and provide the least amount of network bandwidth and speed of the three illustrated examples. Network #3 may be a private home network that includes little security structures (e.g., a simple firewall, etc.) and a medium level of network bandwidth and speed, between that of Networks #1 and #2.

In the illustrated embodiment, as the user or device 102 moves between networks #1, #2, and #3, device 102 may maintain and dynamically change its NI Strategy. In this context, a NI Strategy may include the definition of one or more NI Groups and the criteria employed to allocate or select which of those NIs in NI Groups are to fulfill various network resource access requests.

In the illustrated embodiment, when device 102 is connected with network #1 (illustrated as area 402) and connected with network #2 (illustrated as area 404), device 102 may employ a first NI Strategy 452. In such an embodiment, NI Strategy 452 may include, for example, attempting to fulfill all access requests over the work network #1 and its associated NI. In such an embodiment, this may be done to reduce the usage of an aggregated bandwidth cap associated with cellular Network #2. In another embodiment, NI Strategy 452 may be to allocate the network resources of a work nature (e.g., detected via their network address, requesting application, etc.) via NI connected with work Network #1 and personal or non-work related network resources via NI connected with cellular Network #2. It is understood that the above are merely a few illustrative examples to which the disclosed subject matter is not limited.

As the user leaves work for lunch or otherwise, device 102 may detect that Network #1 has become disconnected (e.g., the status of the associated NI may change, etc.) and that only the cellular Network #2 is accessible. In various embodiments, device 102 may dynamically switch to NI Strategy 454. In such an embodiment, NI Strategy 454 may simply be to access any requested network resources via NI coupled with Network #2.

As the user enters their home, device 102 may detect that Network #3 has become connected (e.g., the status of the associated NI may change, etc.; illustrated by area 406) and that both the cellular Network #2 and the home Network #3 are accessible. In various embodiments, device 102 may dynamically switch to NI Strategy 456. In some embodiments, this NI Strategy 456 may be substantially equivalent to versions of NI Strategy 452 except with Network #3 replacing Network #1. For example, all network resource accesses may prefer the faster or non-bandwidth capped non-cellular network (i.e., Networks #1 or #3). In another embodiment, the Network #3 may also face a bandwidth cap or throttling and NI Strategy 456 may reflect a balancing amongst the costs or inconvenient of the two networks #2 and #3 bandwidth caps or other limitations. It is understood that the above are merely a few illustrative examples to which the disclosed subject matter is not limited.

In various embodiments, the user or device 102 may enter a portion where only Network #3 is accessible and again device 102 may dynamically switch to a NI Strategy 458 that allocates or selects which NI to use based upon only Network #3s availability. As device 102 moves back into an area where Network #2 is connected, device 102 may dynamically switch back to NI Strategy 456. Likewise as device 102 exits the home Network #2 and is only accessible to Network #3, NI Strategy may return to NI Strategy 454.

Finally, in the illustrated embodiment, device 102 may again be connected both to work Network #1 and cellular Network #2. However, in the illustrated embodiment, instead of dynamically returning to NI Strategy 452 other networking conditions may have changed such that a new NI Strategy 459 is employed. For example, in one embodiment, device 102 may be nearing, exceeding, or at a predefined threshold of the bandwidth cap imposed by cellular Network #2. In such an embodiment, NI Strategy 459 may reflect an increased preference for accessing network resources via Network #1 and a lowered preference for privacy (e.g., avoiding the Network #1 security measures, etc.), speed via parallel access of multiple resources, etc. It is understood that the above are merely a few illustrative examples to which the disclosed subject matter is not limited.

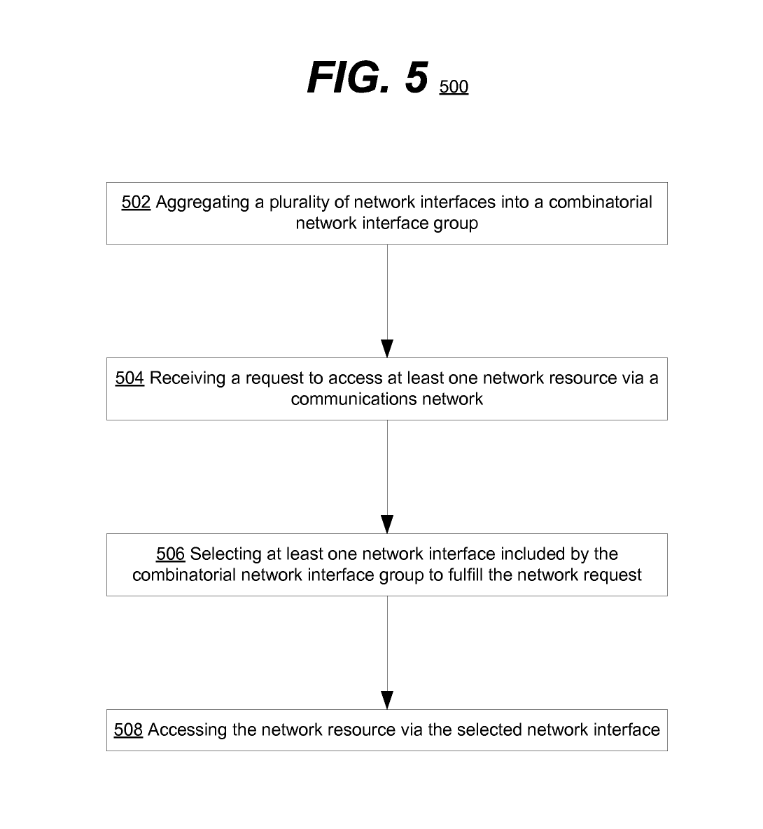

FIG. 5 is a flowchart of an example embodiment of a technique 500 in accordance with the disclosed subject matter. In various embodiments, technique 500 may be used or produced by the systems such as those of FIG. 1, 2, 3, or 4. Although, it is understood that the above are merely a few illustrative examples to which the disclosed subject matter is not limited. It is understood that the disclosed subject matter is not limited to the ordering of or number of actions illustrated by technique 500.

Block 502 illustrates that, in one embodiment, a plurality of network interfaces may be aggregated into a combinatorial network interface group, as described above. In various embodiments, the each network interface may provide a respective amount of bandwidth to at least one communications network, as described above. In some embodiments, aggregating may include selecting from a plurality of network interfaces based upon the communications network associated with a respective network interface, as described above. In various embodiments, one or more of the action(s) illustrated by this Block may be performed by the apparatuses or systems of FIG. 1, 2, 3, or 4, the network interfaces 116, Resource Aggregator 124, NI manager 121 of FIG. 1, 2, or 3, as described above.

Block 504 illustrates that, in one embodiment, a request to access at least one network resource via a communications network may be received, as described above. In one embodiment, the request may be made by an application, as described above. In various embodiments, the request to access at least one network resource via a communications network, as described above. In various embodiments, one or more of the action(s) illustrated by this Block may be performed by the apparatuses or systems of FIG. 1, 2, 3, or 4, application 118 or OS 117 of FIG. 1, 2, or 3, as described above.

Block 506 illustrates that, in one embodiment, at least one network interface included by the combinatorial network interface group may be selected to fulfill the network request, as described above. In some embodiments, the selection may be based, at least in part, upon the bandwidth provided by the combination of bandwidths provided by the selected network interfaces, as described above. In one embodiment, selecting may include selecting a network interface based upon a financial cost of the bandwidth provided by the network interface, as described above. In another embodiment, selecting may include selecting a network interface based upon an aggregate bandwidth cap associated with the network interface, as described above. In yet another embodiment, selecting may include selecting a network interface based upon an address of the network resource, as described above. In various embodiments, one or more of the action(s) illustrated by this Block may be performed by the apparatuses or systems of FIGS. 1, 2, 3, or 4, NI Allocator 122 of FIG. 1, 2, or 3, as described above.

Block 508 illustrates that, in one embodiment, the network resource may be accessed via the selected network interface, as described above. In various embodiments, accessing may include the network resources includes allocating the accessing of each network resource to a corresponding selected network interface, as described above. In some embodiments, accessing may include identifying a division of a network resource into a plurality of sub-portions, and accessing each sub-portion by a respective selected network interface, as described above. In one embodiment, accessing may include dynamically reallocating the accessing of the network resources amongst the selected network interfaces based upon a changed bandwidth provided by at least one of the selected network interfaces, as described above. In another embodiment, the at least one network resource may be provided to the requesting application via a virtual network interface, as described above. In various embodiments, one or more of the action(s) illustrated by this Block may be performed by the apparatuses or systems of FIG. 1, 2, 3, or 4, the Network Interface Group 120, NIs 116, NI Manager 121 of FIG. 1, 2, or 3, as described above.

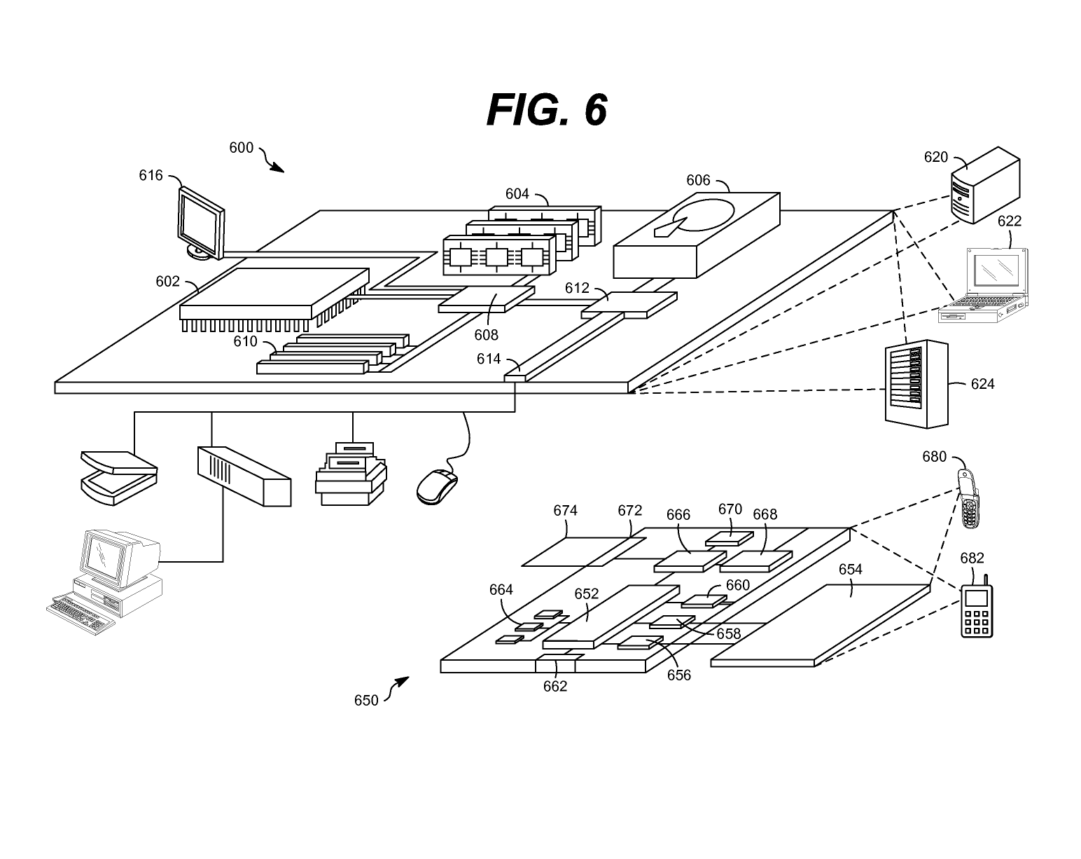

FIG. 6 shows an example of a generic computer device 600 and a generic mobile computer device 650, which may be used with the techniques described here. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, a memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652, that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smart phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A method comprising:
aggregating, by a computing device, a plurality of network interfaces of the computing device into a plurality of combinatorial network interface groups, wherein each network interface of the plurality of network interfaces provides a respective amount of bandwidth of at least one communications network to an application running on at least one processor included in the computing device;
receiving, by the computing device, a request, from the application, to access at least one network resource via a communications network;
selecting, by the computing device, a network interface strategy from a plurality of network interface strategies of the computing device, each network interface strategy of the plurality of network interface strategies defining which of the plurality of combinatorial network interface groups to use and defining an allocation of which network interfaces in the defined plurality of combinatorial network interface groups to use to fulfill the request based on a respective capability of each of the network interfaces in the defined plurality of combinatorial network interface groups;
accessing, by the computing device, the at least one network resource in accordance with the selected network interface strategy, wherein the selected network interface strategy is a first network interface strategy;
detecting, by the computing device, while accessing the at least one network resource in accordance with the first network interface strategy, a change in capability or availability to access the at least one network resource by at least one network interface in the plurality of combinatorial network interface groups defined in the first network interface strategy;
in response to the detected change to access the at least one network resource, dynamically selecting, by the computing device, a second network interface strategy from the plurality of network interface strategies; and
continue accessing, by the computing device, the at least one network resource in accordance with the second network interface strategy.

2. The method of claim 1, wherein the request to access the at least one network resource includes a request to access a plurality of network resources, and
accessing the at least one network resource includes allocating accessing of each of the plurality of network resources in accordance with a corresponding network interface strategy selected from the plurality of network interface strategies.

3. The method of claim 1, wherein selecting the network interface strategy includes selecting the network interface strategy based upon respective monetary costs of the respective amounts of bandwidth provided by each of the plurality of network interfaces.

4. The method of claim 1, wherein selecting the network interface strategy includes selecting the network interface strategy based upon an aggregate bandwidth cap associated with at least one of the plurality of network interfaces.

5. The method of claim 1, wherein selecting the network interface strategy includes selecting the network interface strategy based upon an address of the at least one network resource.

6. The method of claim 1, further comprising:
providing the at least one network resource to the application via a virtual network interface.

7. The method of claim 1, wherein aggregating the plurality of network interfaces into the plurality of combinatorial network interface groups includes aggregating the plurality of network interfaces based upon respective communications networks associated with each of the plurality of network interfaces.

8. (canceled)

9. (canceled)

10. An apparatus comprising:
a plurality of network interfaces, wherein each network interface facilitates communication between the apparatus and at least one communications network; and
a processor configured to cause the apparatus to:
aggregate at least a portion of the plurality of network interfaces into a plurality of combinatorial network interface groups,
execute an application on the apparatus,
receive, from the application, a request to access at least one network resource via a communications network,
select a network interface strategy from a plurality of network interface strategies of the apparatus, each network interface strategy of the plurality of network interface strategies defining which of the plurality of combinatorial network interface groups to use and defining an allocation of which network interfaces in the defined plurality of combinatorial network interface groups to use to fulfill the request based on a respective capability of each of the network interfaces in the defined plurality of combinatorial network interface groups,
access the at least one network resource in accordance with the selected network interface strategy, wherein the selected network interface strategy is a first network interface strategy,
detect, while accessing the at least one network resource in accordance with the first network interface strategy, a change in capability or availability to access the at least one network resource by at least one network interface in the plurality of combinatorial network interface groups defined in the first network interface strategy,
in response to the detected change to access the at least one network resource, dynamically select a second network interface strategy from the plurality of network interface strategies, and
continue to access the at least one network resource in accordance with the second network interface strategy.

11. The apparatus of claim 10, wherein the request to access the at least one network resource includes a request to access a plurality of network resources; and
the apparatus is further configured to allocate access to each of the plurality of network resources in accordance with a corresponding network interface strategy selected from the plurality of network interface strategies.

12. The apparatus of claim 10, wherein the processor further causes the apparatus to select the network interface strategy based upon respective monetary costs of the respective amounts of bandwidth provided by each network interface of the at least the portion of the plurality of network interfaces.

13. The apparatus of claim 10, wherein the processor further causes the apparatus to select the network interface strategy based upon respective aggregate bandwidth caps associated with each network interface of the at least the portion of the plurality of network interfaces.

14. The apparatus of claim 10, wherein the processor further causes the apparatus to select the-network interface strategy based upon an address of the at least one network resource.

15. The apparatus of claim 10, wherein the processor further causes the apparatus to provide the at least one network resource via a virtual network interface.

16. The apparatus of claim 10, wherein the processor further causes the apparatus to aggregate the at least the portion of the plurality of network interfaces into the plurality of combinatorial network interface groups based upon respective communications networks associated with each network interface of the at least the portion of the plurality of network interfaces.

17. (canceled)

18. (canceled)

19. A computer program product for accessing information, the computer program product being tangibly embodied on a non-transitory computer-readable medium and including executable code that, when executed, is configured to cause a computing device to:
aggregate a plurality of network interfaces of the computing device into a plurality of combinatorial network interface groups, wherein each network interface of the plurality of network interfaces provides a respective amount of bandwidth of at least one communications network to an application running on the computing device;
receive a request, from the application, to access at least one network resource via a communications network;
select a network interface strategy from a plurality of network interface strategies of the computing device, each network interface strategy of the plurality of network interface strategies defining which of the plurality of combinatorial network interface groups to use and defining an allocation of which network interfaces in the defined plurality of combinatorial network interface groups to use to fulfill the request based on a respective capability of each of the network interfaces in the defined plurality of combinatorial network interface groups;
access the at least one network resources in accordance with the selected network interface strategy, wherein the selected network interface strategy is a first network interface strategy;
detect, while accessing the at least one network resource in accordance with the first network interface strategy, a change in capability or availability to access the at least one network resource by at least one network interface in the plurality of combinatorial network interface groups defined in the first network interface strategy;
in response to the detected change to access the at least one network resource, dynamically select a second network interface strategy from the plurality of network interface strategies; and
continue to access the at least one network resource in accordance with the second network interface strategy.

20. (canceled)

21. The method of claim 1, wherein the plurality of network interfaces includes at least two cellular network interfaces.

22. The apparatus of claim 10, wherein the plurality of network interfaces includes at least two cellular network interfaces.

23. The computer program product of claim 19, wherein the plurality of network interfaces includes at least two cellular network interfaces.

24. The method of claim 1, wherein accessing the at least one network resource includes accessing the at least one network resource using the defined network interfaces in the defined plurality of combinatorial network interface groups simultaneously to fulfill the request.
